(19) United States
(12) Patent Application Publication
(10) Pub. No.: US 2006/0099024 A1
(43) Pub. Date: May 11, 2006

(54) Mechanism of rotating lipstick case

(76) Inventors: Stephane Demellier, Talloires (FR); Pierre Joulia, Saint Jorioz (FR)

Correspondence Address: FAY, SHARPE, FAGAN, MINNICH & MCKEE, LLP, 1100 SUPERIOR AVENUE, SEVENTH FLOOR, CLEVELAND, OH, 44114, US

(21) Appl. No.: 10/524,156

(22) PCT Filed: Aug. 7, 2003
(86) PCT No.: PCT/FR03/02488

§ 371 Date: Sep. 23, 2005

(30) Foreign Application Priority Data
Aug. 8, 2002 (FR) 02/10121

(51) Int. Cl. B43K 21/08; B43K 5/06

(52) U.S. Cl. 401/75; 401/172

(57) ABSTRACT

A revolving case (1) comprises a base (2) mounted mobile in axial rotation relative to a tubular body (3). A slide (4) for receiving a product to be protected is movably mounted in the base, the base (2) comprises a guide (20) for driving the slide (4) in axial translation when the base (2) is axially rotated relative to the tubular body (3). The axial rotation of the base (2) relative to the tubular body (3) drives the slide (4) simultaneously in rotation and in axial translation relative to said tubular body (3). The height of the slide (4) and the height of the guide (20) are not greater than the external height of the base (2).

The present invention concerns a rotating case, like those used to contain cosmetic products, such as lipstick or labial creams.

Many rotating cases are known that allow the extraction and retraction of a product inside a protective casing.

Such rotating cases are composed of a movable base mounted in axial rotation in comparison with a tubular body the interior of which is movably mounted in movement a slide destined to receive a product to protect. The base includes a means of guidance capable of inducing movement in the slide with the rotation of the aforementioned base. The body is arranged in such a way that the same induced rotation of the slide in a spiraling motion to the interior of the tubular body.

The already perfected commercial tubes of lipstick present a number of inconveniences.

In fact the lipstick is not visible from the exterior, particularly when the slide is completely retracted into the base. Most current tubes are constituted of many pieces.

The present invention wants to resolve the inconveniencies of the traditional system, while proposing a rotating case that allows the product contained inside to be viewed from the outside, even when the slide is completely retracted into the base. This characteristic has an equally practical interest, since it allows the user to determine how much of the product remains without having to open the rotating mechanism.

Also the technical problem to be resolved, by the object of the present invention, is to propose a rotating casing having a base movably mounted in axial rotation in comparison with a tubular body to interior of which is mounted movably a slide destined to receive a product to protect, the base having a means of guidance capable of inducing the slide in axial translation in comparison with it at the time of axial rotation of the aforementioned base in comparison to the tubular body, the axial rotation of the base in comparison to the tubular body being in addition capable of inducing the slide simultaneously in rotation and in axial translation in comparison to the aforementioned tubular body, the rotating case which would avoid the problems of current techniques while also avoiding that the internal structure of the case be visible to the exterior through the body, all while guaranteeing on the other hand a maximum visibility of the product.

The solution to the posed technical problem is, according to the present invention, that the height of the slide and the means of guidance are less then or equal to the external height of the base.

The invention such as is defined presents the advantage to improve noticeably the aesthetics of the rotating case. In its retracted position, only the base, and by transparency the protected product, are visible to the outside. What's more, the compactness of the rotating case is preserved.

The other characteristics and advantages of the invention will reveal themselves in the description that will follow and by looking at the attached drawings which are given only by way of non restrictive examples.

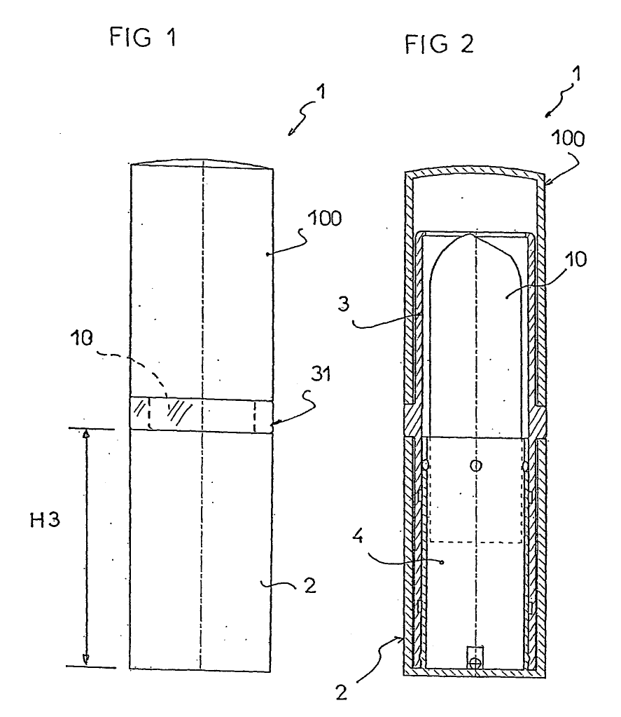

FIG. 1 is an external view of the tube of lipstick of the invention.

FIG. 2 is a longitudinal sectional view of the tube, the slide being in its lowered position.

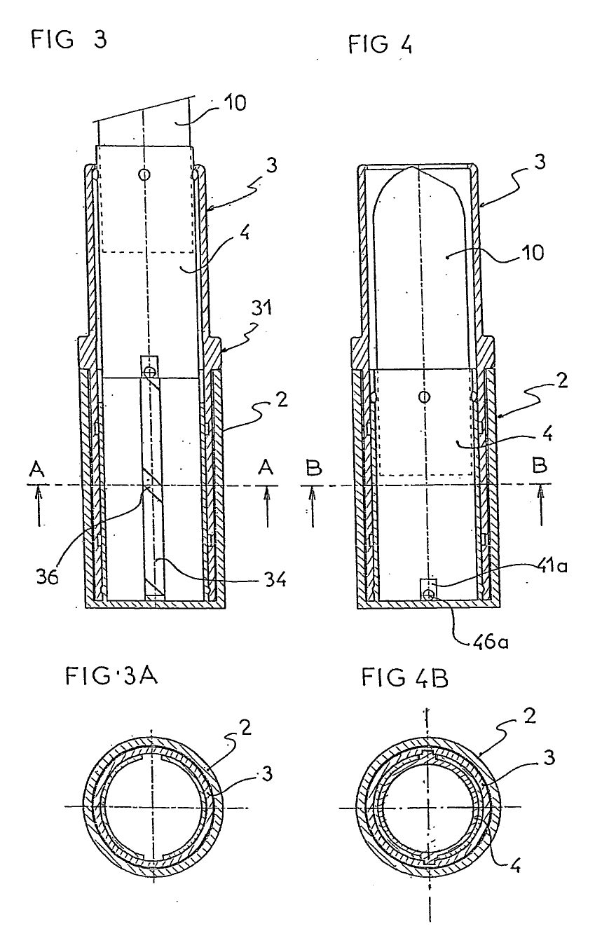

FIG. 3 and 4 are longitudinal sectional views of the tube without the cap, the slide is in its raised and lowered positions respectively.

FIG. 3A is a view along section line A-A in FIG. 3.

FIG. 4B is a view along section line B-B in FIG. 4.

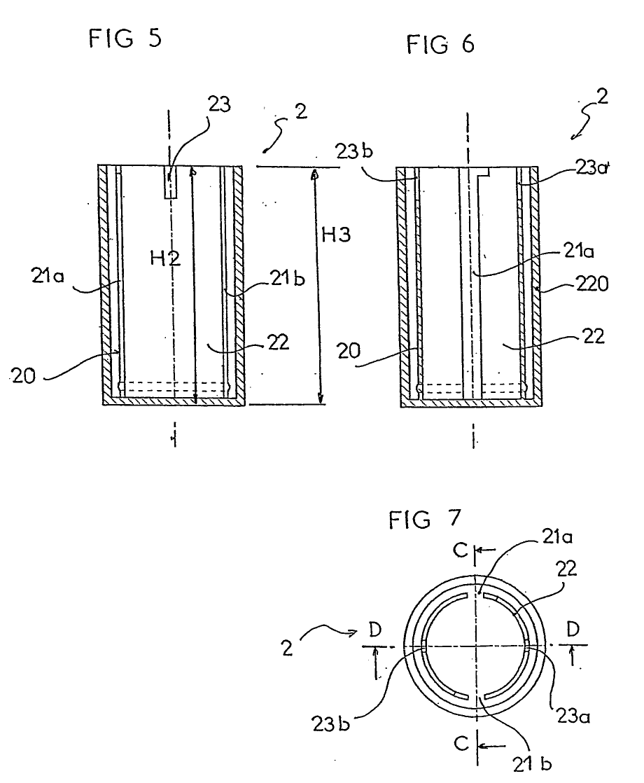

FIGS. 5, 6 and 7 represent the base of the rotating case, respectively, along section lines D-D and C-C in FIG. 7 which is a view from above.

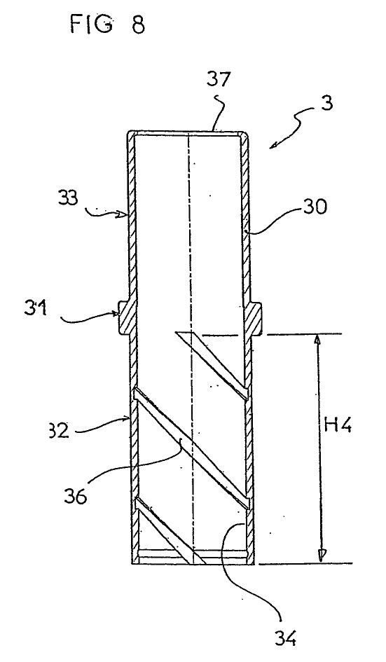

FIG. 8 shows a longitudinal section of the tubular body of the rotating casing.

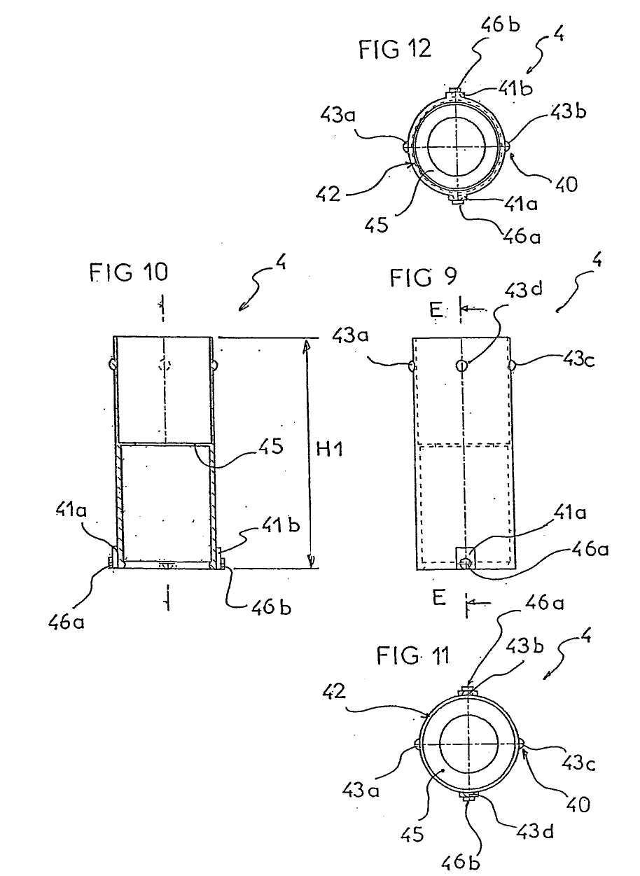

FIGS. 9, 10, 11 and 12 represent the slide, respectively, an external view (FIG. 9), a longitudinal view along section E-E (FIG. 10), a view from above (FIG. 11), and a view from below (FIG. 12).

FIGS. 1 through 12 illustrate a rotating case 1 according to the particular preferred embodiment of the invention, chosen only by way of the example.

The rotating case 1 has a base 2 movably mounted in axial rotation around a tubular body 3 to interior of which mounted movably is a slide destined to receive a product to protect, herein the “grape” or stick 10.

The base 2 more particularly is endowed with a means of guidance 20 capable of inducing the slide 4 in axial translation relative to it, at the time of axial rotation of the aforementioned base 2 around the tubular body 3. The body is arranged manner so that the axial rotation of the base 2 is, in addition, capable of inducing the slide 4 in a spiraling motion decomposing itself in rotation and translation, the two simultaneously and axially in comparison with the tubular body 3.

Thus one can see it especially in FIG. 4, and in accordance with the object of the present invention, the height (H1) of slide 4 and the height (H2) of the means of guidance 20 are less than or equal to the external height (H3) base 2, this is to say at its apparent exterior height.

In this example, the heights in question are identical for it is a matter of an optimized preferred embodiment. But it is well evident that what is important is that the respective dimensions of the slide 4 and the means of guidance 20 are not superior to those of the base 2. The external portion of the base 2 in fact, masks at once the slide 4 and the means of guidance 20 when the rotating case is in the retracted position, that is to say when the slide is in its lowered position.

FIG. 5, 6, and 7 specifically illustrate the base 2, which presents a complementary form to the lower end 32 of tubular body 3, and includes coincidently of a tube closed at its lower end. This section is equally circular in order to allow axial rotation.

According to the specifics of the present invention, the means of guidance 20 has at least one vertical rectilinear groove 21a, 21b arranged longitudinally in at least a side portion of the internal tube 22 extending itself in a concentric way inside the base 2; each of the guiding grooves 21a, 21b being capable of cooperating with a first means of guidance 41a, 41b carried by the slide 4. The cooperation between the guiding protrusions 41a, 41b and the guiding grooves 21a, 21b moves the slide 4 in axial translation in comparison with the base 2, with the axial rotation of aforementioned base 2 around the tubular body 3.

In the preferred embodiment, there are two rectilinear guiding grooves 21a, 21b. They are arranged longitudinally, and symmetrically in relation to the axis of the rotating case, in the side internal tube 22 that spreads itself to the interior and in a concentric way in comparison with the exterior peripheral portion 220 of the base 2.

The inside tube 22 is here in its entirety but it is well evident that each guiding groove 21a, 21b could be arranged independently on an individual portion of the side tube.

FIG. 8 illustrates the tubular body 3 which is placed in the rotating case.

Like its name indicates, the tubular body 3 presents itself in the form of a tube with circular cross-sections. A ring shaped rib 31 extends radially from the external surface, preferably half way up. Thus, the rib defines an inferior side 32 designed to receive the base 2 movably mounted for rotation, and an upper side designed to receive a removable closing cover 100 of a suitably complementary form.

The internal surface 34 has besides, at the level of the lower end 32 of the tubular body 3, at least one spiral groove 36 which is able to cooperate with the second means of guidance 46a, 46b carried with the slide 4. In the preferred embodiment, the body includes two spiral grooves.

The cooperation between the second means of guidance 46a, 46b and the spiral grooves 36 induces the slide 4 simultaneously in rotation and axial translation with respect to the tubular body 3, at the time of the axial rotation of the base 2 around aforesaid tubular body 3.

According to a characteristic of the invention, the tubular body 3 is transparent. In a particularly advantageous implementation, the slide 4 is equally transparent.

FIGS. 9, 10, 11, and 12 illustrate the slide 4 which is mounted in the rotating case.

The aforementioned slide is made up of a tube 42 whose diameter is obviously complementary to the internal section of the tubular body 3. The aforementioned tube 42 includes in its central zone a bottom 45 made up by a transverse partition. The respective internal partitions of tube 42 and the bottom 45 set the limits of the space designed to support the stick 10.

According to the specifics of the invention, the slide requires a means of centering 40, forming runners, which are capable of cooperating by contact with the internal surface 34 of the tubular body 3.

In this special preferred embodiment, the means of centering 40 require four means of centering 43a, 43b, 43c, 43d uniformly distributed on the external surface of the superior side of the slide 4, that is to say in a square. It is well evident that the number of means of centering 43a, 43b, 43c, 43d could be different. One will notice that three means of centering positioned in a triangle constitute a minimal configuration to guide, in am optimum way, the movement of the cylindrical element inside the tubular element.

It is equally noted that the centering on the low end of the slide 4 is embodied, in one part, by the cooperation between the first means of guiding 41a, 41b and the guiding grooves 21a, 21b, and also, by the cooperation between the second means of guiding 46a, 46b and the spiral grooves 36.

In an advantageous way, the means of centering 43a, 43b, 43c, 43d are equally able to cooperate by contact with an internal edge, forming a lip 37, interacting with the superior extremity of the tubular body 3. The goal is to limit how high the slide can go.

Let us add that the means of guidance 20 includes additional longitudinal and rectilinear retaining grooves 23a, 23b, which are capable of receiving the means of centering 43a, 43b, 43c, 43d when the slide is retracted all the way inside the base 2.

According to a complimentary characteristic, the means of centering 43a, 43b, 43c, 43d are capable of being engaged in the guiding grooves 21a, 21b intended for the guidance of the slide in translation in the base 2. This advantageous characteristic limits the number of the retaining grooves 23a, 23b.

But according to another characteristic of the invention, the first means of guiding 41a, 41b have portions of larger dimensions than the retaining grooves 23a, 23b which are designed to receive the means of centering 43a, 43b, 43c, 43d. This advantageous characteristic prevents the first means of guiding 41a, 41b from entering the retaining grooves 23a, 23b, this is in order to guarantee a correct mounting of the rotating case during manufacturing or after all dismantling operations. The retaining grooves 23a, 23b have, in effect, a noticeably smaller length than the guiding grooves 21a, 21b. This means that the retaining grooves 23a, 23b are specialized, and different from the guiding grooves 21a, 21b which can receive the means of guiding 41a, 41b and the means of centering 43a, 43b, 43c, 43d at once.

The rotating case according to the invention is endowed with a removable cap 100 which is removably attached to the free end of the tubular body, for example by a clip.

Let us add that in the closed position the tube of lipstick such as is represented by FIGS. 1 and 2, the ring-shaped rib 31 is arranged between the inferior edge of the cap 100 and the superior edge of the base, this allows the user to see the lipstick through the transparent body, the slide being totally enclosed inside the base.

Incidentally according to an advantageous arrangement, the spiral grooves 36 extend to a height (H4) less than or equal to the height of the base.

Of course, the invention is not limited to the preferred embodiments described and represented by the title of this example, but it also includes all the equivalent techniques and their combinations.

1. A rotating case comprising:
a base mounted movably for axial rotation around a tubular body;
a slide adapted to receive stick movably mounted in an interior of the tubular body, the base including a means of guidance for inducing the slide to move in axial translation with the axial rotation of the base relative to the tubular body, the axial rotation of the base relative to the tubular body further inducing the slide to rotate and axially translate simultaneously relative to the tubular body, a height of the slide and a height of the means of guidance being less than or equal to an external height of the base.

2. The rotating case according to claim 1, wherein the means of guidance includes at least one rectilinear guiding groove which extends longitudinally along at least one portion of an inside tube which extends concentrically in an interior of the base, the guiding groove cooperating in a running relationship to the means of guidance interdependent with the slide.

3. The rotating case according to claim 1, wherein the slide includes a means of centering cooperating by contact with an internal surface of the tubular body.

4. The rotating case according to claim 3, wherein the means of centering includes at least two means of centering regularly spaced on an external surface of an upper end of the slide.

5. The rotating case according to claim 1, wherein the means of guidance includes longitudinal and rectilinear grooves which receive the means of centering when the slide is retracted to the interior of the base.

6. The rotating case according to claim 4, wherein the means of centering are received in the guiding grooves to guide the slide along the interior of the base.

7. The rotating case according to claim 4, wherein the means of centering cooperate by contact with an edge interacting with the upper end of the tubular body to limit the course of the slide.

8. The rotating case according to claim 2, each wherein the means of guiding have larger dimensions than storage grooves which receive the means of centering.

9. The rotating case according to claim 1, wherein the tubular body is transparent.

10. The rotating case according to claim 1, wherein the tubular body is a tube with circular cross-sections, a ring-shaped rib extends radially from the external surface half-way up the body tube setting the limits for movement, a lower end of the body tube rotatably receives the base and upper end of the body tube receives a removable cap of complementary form.

11. The rotating case according to claim 1, wherein the slide is transparent.

12. The rotating case according to claim 1, further including: a cap removably attached to an upper end of the tubular body.

13. A rotating case comprising:
a body tube defining a spiral groove along a lower interior surface thereof, the body tube defining an exterior rib centrally therearound;
a base having an outer portion which rotatably receives a lower end of the tubular body and abutting a lower surface of the rib and an inner portion which extends rotatably into the tubular body, the inner portion defining at least one longitudinal guide groove;
a slide having a longitudinal length which is less than or equal to a longitudinal length of the base, the slide being movably received in the base interior portion, the slide including at least one or more projections which each engage one or more of the longitudinal guide groove and the spiral groove such that as the base rotates relative to the tubular body, the slide projections are cammed by the spiral groove to move upward in the tubular body and are restrained by the longitudinal guidance groove to move longitudinally.

14. The rotating case according to claim 13 wherein the slide includes at least one detent projecting outward adjacent an upper end therefrom;
an upper end of the tubular body including an inward extending lip for engaging the detent to limit longitudinal movement of the slide; and
the base including at least one storing groove adjacent an upper end thereof to receive the detent when the slide is in a fully retracted position.
